(19) United States
(12) Patent Application Publication
(10) Pub. No.: US 2010/0133162 A1
(43) Pub. Date: Jun. 3, 2010

(54) Ultrasonic Humidifier with a Mist Purifying Member Containing Silver Ions

(76) Inventor: Chih-Li Huang, Tainan City (TW)

Correspondence Address: KRAMER LEVIN NAFTALIS & FRANKEL LLP;INTELLECTUAL PROPERTY DEPARTMENT, 1177 AVENUE OF THE AMERICAS, NEW YORK, NY, 10036, US

(21) Appl. No.: 12/325,696

(22) Filed: Dec. 1, 2008

(51) Int. Cl. C02F 1/42

(52) U.S. Cl. 210/206

(57) ABSTRACT

An ultrasonic humidifier includes a base that is formed with a recess, as well as a water tank and a mist spraying tube that are disposed on the base and that are in fluid communication with the recess. An ultrasonic oscillator is disposed in a bottom end of the recess for atomizing water in the recess. A mist purifying member is disposed within the mist spraying tube, and contains silver ions.

### BACKGROUND OF THE INVENTION

1. Field of the Invention

This invention relates to a humidifier, and more particularly to an ultrasonic humidifier.

2. Description of the Related Art

Referring to FIG. 1, a conventional ultrasonic humidifier 1 includes a base 11, a water tank 12 disposed on the base 11, a mist spraying tube 13 disposed on the water tank 12, and an ultrasonic oscillator 14 disposed on the base 11. The base 11 has a top surface that is formed with a recess 111 in fluid communication with the water tank 12 and the mist spraying tube 13. The ultrasonic oscillator 14 is disposed in a bottom end of the recess 111.

In use, the water tank 12 is filled with an amount of water to be atomized. The water flows from the water tank 12 into the recess 111 to contact the ultrasonic oscillator 14. Hence, the water in the recess 111 is atomized to form mist. The mist is blown into the atmosphere through the mist spraying tube 13 to increase the moisture in the ambient air.

To obtain high-quality humidified air, it is necessary to fed high-quality water into the water tank 12 and maintain cleanness within the ultrasonic humidifier 1. In addition, when bacteria grow in the ultrasonic humidifier 1 to create a bad odor, it is necessary to kill the bacteria and remove the bad odor. However, the aforesaid ultrasonic humidifier 1 cannot solve the bacteria growth problem. As a result, the bacteria and the bad odor will be moved along with the mist from the ultrasonic humidifier 1 into the humidified air. Thus, the humidified air may be harmful to heath and have unpleasant odor.

### SUMMARY OF THE INVENTION

The object of this invention is to provide an ultrasonic humidifier that includes a mist purifying member containing silver ions for purifying the mist flowing through a mist-spraying tube.

According to this invention, an ultrasonic humidifier includes a base that is formed with a recess, as well as a water tank and a mist spraying tube that are disposed on the base and that are in fluid communication with the recess. An ultrasonic oscillator is disposed in a bottom end of the recess for atomizing water in the recess. A mist purifying member is disposed within the mist spraying tube, and contains silver ions.

### BRIEF DESCRIPTION OF THE DRAWINGS

These and other features and advantages of this invention will become apparent in the following detailed description of the preferred embodiments of this invention, with reference to the accompanying drawings, in which:

FIG. 1 is a partly sectional side view of a conventional ultrasonic humidifier;

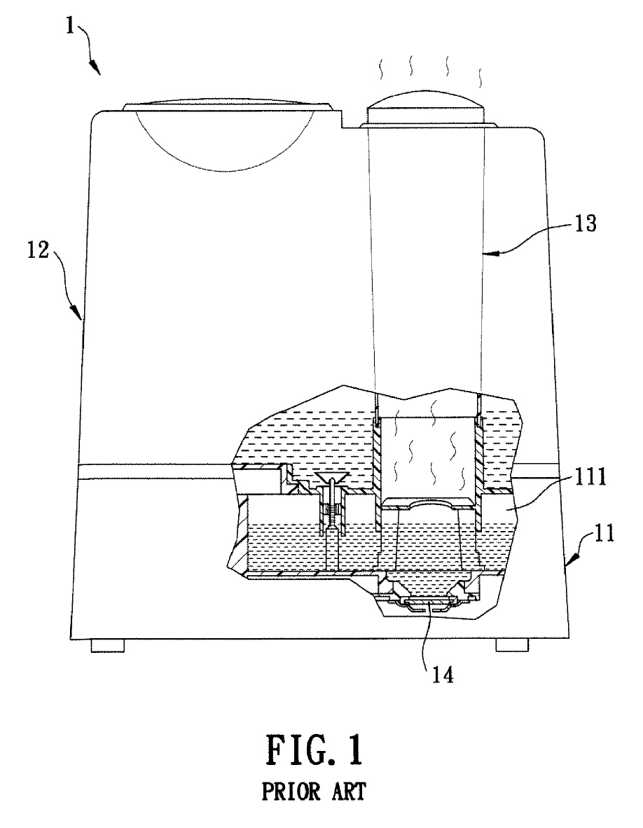

FIG. 2 is a partly exploded perspective view of the first preferred embodiment of an ultrasonic humidifier according to this invention;

FIG. 3 is a partly sectional side view of the first preferred embodiment; and

FIG. 4 is a partly sectional side view of the second preferred embodiment of an ultrasonic humidifier according to this invention.

### DETAILED DESCRIPTION OF THE PREFERRED EMBODIMENTS

Before the present invention is described in greater detail in connection with the preferred embodiments, it should be noted that similar elements and structures are designated by like reference numerals throughout the entire disclosure.

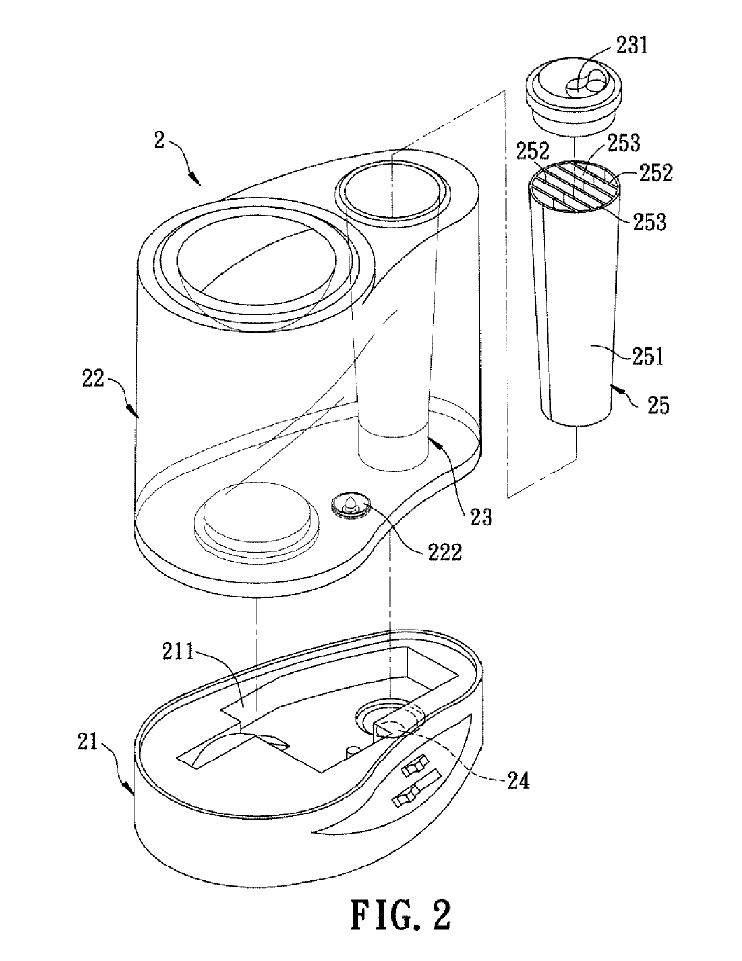

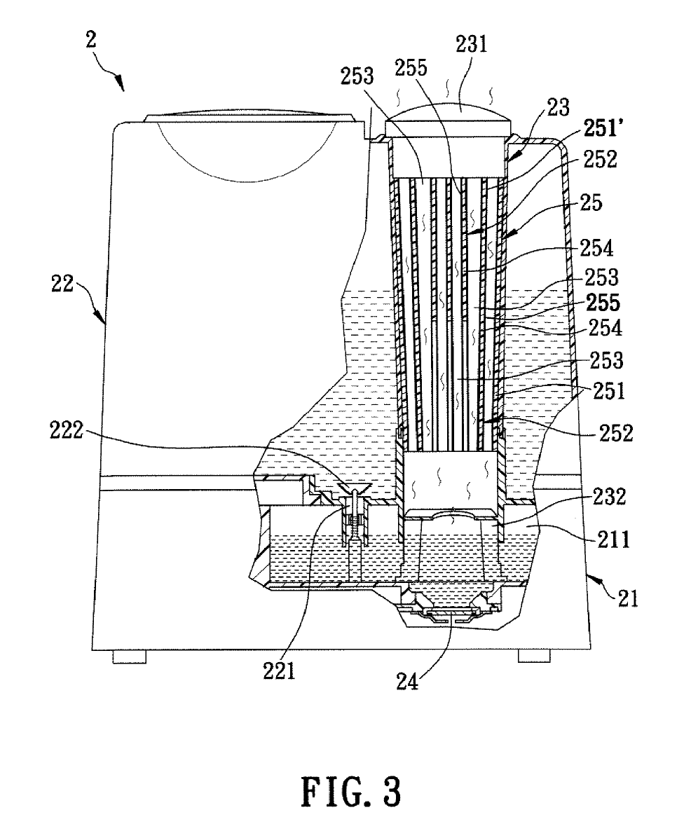

Referring to FIGS. 2 and 3, the first preferred embodiment of an ultrasonic humidifier 2 according to this invention includes a base 21, a water tank 22 disposed on the base 21, a mist spraying tube 23 disposed on the base 21, an ultrasonic oscillator 24 disposed in the base 21, and a mist purifying member 25 disposed in the mist spraying tube 23.

The base 21 has a top surface that is formed with a recess 211.

The water tank 22 has a water supply port 221 in fluid communication with the recess 211 in the base 21, and a valve 222 disposed within the water supply port 221 in a known manner for controlling opening and closing of the water supply port 221.

The mist spraying tube 23 includes a tube body 231 disposed on the base 21 and having a mist outlet 232 disposed at an upper end thereof and in fluid communication with the environment, and a mist inlet 232 disposed at a lower end thereof and in fluid communication with the recess 211 in the base 21.

The ultrasonic oscillator 24 is disposed in a bottom end of the recess 211 in the base 21.

The mist purifying member 25 includes a tubular body 251 disposed removably within the mist spraying tube 23 and defining an interior space, and a plurality of spaced-apart, upright, silver-ion-containing partitions 252 disposed within the tubular body 251 to divide the interior space in the tubular body 251 into a plurality of mist passages 253. Lower ends of three middle ones of the partitions 252 are higher than those of two outer ones of the partitions 252. Each of the silver-ion-containing partitions 252 includes a plate body 254, and a sliver-ion coating 255 applied on an outer surface of the plate body 254.

In use, the water tank 22 is filled with an amount of water to be atomized. The water flows from the water tank 22 into the recess 211 in the base 21 via the water supply port 221. Subsequently, the ultrasonic oscillator 24 is driven to atomize the water in the recess 211 in the base 21 to form mist. The mist is blown into the atmosphere through the mist passages 253 in the mist spraying tube 23 to increase the moisture in the ambient air. During flow of the mist through the mist spraying tube 23, the mist comes into contact with the silver-ion coatings 255. As such, bacteria in the mist are killed, and bad odor in the mist is removed to allow a comparatively high purification of mist to be sprayed into the ambient air.

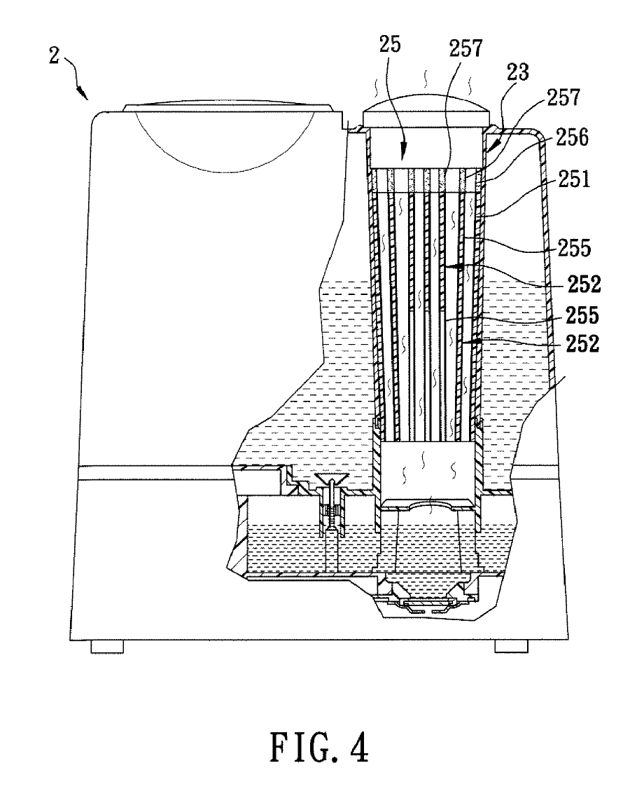

FIG. 4 shows the second preferred embodiment of an ultrasonic humidifier 2 according to this invention, which is similar in construction to the first preferred embodiment. In this embodiment, the tubular body 251 of the mist purifying member 25 has an outlet end 251′ permitting the mist to flow out of the tubular body 251 therethrough, and the mist purifying member 25 further includes an absorbing ring 257 made of active carbon and abutting against the outlet end 251′ of the tubular body 251, and a plurality of spaced-apart absorbing plates 257 made of active carbon, disposed within the absorbing ring 256, and abutting respectively against the silver-ion-containing partitions 252.

With this invention thus explained, it is apparent that numerous modifications and variations can be made without departing from the scope and spirit of this invention. It is therefore intended that this invention be limited only as indicated by the appended claims.

I claim:

1. An ultrasonic humidifier comprising:
a base having a top surface formed with a recess;
a water tank disposed on said base and in fluid communication with said recess in said base;
a mist spraying tube disposed on said base and in fluid communication with said recess in said base;
an ultrasonic oscillator disposed in a bottom end of said recess in said base for atomizing water in said recess in said base to form mist, said mist flowing through said mist spraying tube; and
a mist purifying member disposed within said mist spraying tube and containing silver ions.

2. The ultrasonic humidifier as claimed in claim 1, wherein said mist purifying member includes a tubular body disposed removably within said mist spraying tube and defining an interior space, and a plurality of spaced-apart, upright, silver-ion-containing partitions disposed within said tubular body to divide said interior space in said tubular body into a plurality of mist passages so that the mist flows through said mist passages.

3. The ultrasonic humidifier as claimed in claim 2, wherein each of said silver-ion-containing partitions of said mist purifying member includes a plate body, and a silver-ion coating applied on an outer surface of said plate body.

4. The ultrasonic humidifier as claimed in claim 2, wherein said tubular body of said mist purifying member has an outlet end permitting the mist to flow out of said tubular body therethrough, and said mist purifying member further includes an absorbing ring made of active carbon and abutting against said outlet end of said tubular body, and a plurality of spaced-apart absorbing plates made of active carbon, disposed within said absorbing ring, and abutting respectively against said silver-ion-containing partitions.

5. The ultrasonic humidifier as claimed in claim 1, wherein said water tank has a water supply port in fluid communication with said recess in said base, and a valve for controlling opening and closing of said water supply port in said water tank.

6. The ultrasonic humidifier as claimed in claim 1, wherein said mist spraying tube has a mist outlet disposed at an upper end thereof and permitting flow of the mist out of said humidifier therethrough, and a mist inlet disposed at a lower end thereof and in fluid communication with said recess in said base.
